(19) United States
(12) Patent Application Publication
(10) Pub. No.: US 2007/0045354 A1
(43) Pub. Date: Mar. 1, 2007

(54) Contact lens care product

(76) Inventors: Karen Boyd, Lawrenceville, GA (US); Karen Frances Lindley, Cumming, GA (US); Frans Theodorus Mahieu, Alpharetta, GA (US); Vincent Bowman, Highland Park, IL (US)

Correspondence Address: NOVARTIS;CORPORATE INTELLECTUAL PROPERTY, ONE HEALTH PLAZA 104/3, EAST HANOVER, NJ, 07936-1080, US

(21) Appl. No.: 11/512,653

(22) Filed: Aug. 30, 2006

Related U.S. Application Data
(60) Provisional application No. 60/712,862, filed on Aug. 31, 2005.

(51) Int. Cl. B65D 47/18; B67D 5/38; B65D 37/00

(52) U.S. Cl. 222/420; 222/154; 222/215

(57) ABSTRACT

The present invention includes a lens care product that can be used both to treat contact lenses in a lens case and to treat contact lenses while worn in the eye and can provide to an user an ability to clean and rewet lenses anytime anywhere without taking them out. The lens care product includes: a lens-care solution capable of cleaning, disinfecting, and/or rinsing contact lenses in a lens case and cleaning and lubricating in the eye while being worn; and a solution dispensing container containing the lens-care solution therein, wherein the container is capable of dispensing the lens solution into the lens case and applying the lens-care solution directly into the eye.

This application claims the benefit under 35 USC § 119 (e) of U.S. provisional application No. 60/712,862 filed Aug. 31, 2005 incorporated by reference in it's entirety.

The invention is generally related to a contact lens care product. More specifically, the invention provides a lens care product capable of treating contact lenses while worn in the eye and in a lens care case.

### BACKGROUND OF THE INVENTION

Contact lenses provide a means for vision correction for a wide range of consumers. The advantages of contact lens wear are numerous. Improved convenience and improved appearance in comparison to spectacle glasses are probably the two most important advantages to most consumers. However, contact lenses require stringent care regimes in order to ensure comfort and avoid ocular infections. Proper care of contact lenses typically requires the consumer to periodically clean, disinfect, and/or rinse the lenses. Cleaning usually refers to removal of lipids, proteins or other matter which has become affixed to a lens. Disinfecting usually refers to inactivating of harmful bacteria or fungi whenever the lenses are removed from the eye, which is usually on a daily basis. Rinsing usually refers to removing debris from the lens before placing the lens in the eye.

Traditionally, disinfecting, cleaning and/or rinsing of lenses are not carried out in the eye but occur at the end of day (e.g., in the evening) by immersing a lens in an appropriate lens care solution (for example, a single- or multiple-purpose care solution) in a contact lens case. Such lens cases can be used to store contact lenses between use periods. When it is desired to treat contact lenses, the appropriate contact lens care composition is removed or dispensed from a bottle or container including the composition and passed into the contact lens case in which the contact lenses have been placed. Contact lenses are often left in the lens care solution in the lens case for an extended time, for example, overnight or at least several hours. After treatment, the contact lenses are ready for wear in the eyes of an user. In general, lens care requires the user first taking out of the lenses and then clean, disinfect, and/or rinse them.

But, users may occasionally want to clean and lubricate lenses during the day. Such occasional lens care during the day may be inconvenient for an user since the user needs to take the lenses out of the eyes and then reinsert them into the eyes after cleaning and lubricating. It would be desirable to directly clean and lubricate the lenses in the eyes (i.e., without removing lenses from the eyes).

In addition, a new class of high Dk soft contact lenses, which are made from high oxygen permeable silicone hydrogel materials, have been developed and become commercially available. Such soft contact lenses allow sufficient oxygen permeate through the lens to the cornea and can have minimal adverse effects on corneal health. This new class of high Dk soft contact lenses can be worn in one of two wearing modalities: daily wear and extended wear (i.e., worn overnight and even continuously over a plurality of days, e.g., up to 30 days). With the advent of extended wear modality, conventional lens care regime and conventional lens care solutions can no longer be used to clean and lubricate lenses while worn in the eye, and conventional lens care containers (or bottles or dispensers) are not be able to be used to apply a lens care solution directly in the eye. Conventional lens care containers (or bottles or dispensers) are designed for storing a lens care solution and for dispensing it into a lens care case. But they are not suitable for applying a lens care solution in the eyes. It would be desirable to directly clean and lubricate the lenses in the eyes (i.e., without taking out of the lenses from the eyes).

It would be beneficial to have a lens care product that can be used both to treat contact lenses in a lens case and to treat contact lenses while worn in the eye. It is to the provision of a lens care product meeting these and other needs that the present invention is primarily directed.

### SUMMARY OF THE INVENTION

Generally described, the present invention includes a lens care product that can be used both to treat contact lenses in a lens case and to treat contact lenses while worn in the eye. The lens care product includes: a lens-care solution capable of cleaning, disinfecting, and/or rinsing contact lenses in a lens case and cleaning and lubricating lenses in the eye while being worn; and a solution dispensing container containing the lens-care solution therein, wherein the container is capable of dispensing the lens solution into the lens case and applying the lens-care solution directly into the eye. In this way, the lens care product can provide to the user not only with the cleaning benefits of a multi-purpose-solution (MPS) but also with the lubrication benefits of a rewetting drop, thereby providing to the user an ability to clean and to rewet lenses anytime anywhere without taking them out and an increased comfort without taking them out.

In various example embodiments, the lens care product of the present invention provides functionalities in in-eye cleaning and lubricating of a contact lens, handling (e.g., stable and resistant to tipping over, easy to hold and squeeze, easy to pour a solution into a lens case and to apply the solution directly in an eye, easy to determine how much solution remains in the container, etc.) and storage of the lens care product; and improved portability, convenience and aesthetic appeal to the customer.

The present invention provides the foregoing and other features, and the advantages of the invention will become further apparent from the following detailed description of the example embodiments set forth herein, read in conjunction with the accompanying figures. The detailed description and figures are merely illustrative of the invention and do not limit the scope of the invention, which is defined by the appended claims and equivalents thereof.

### BRIEF DESCRIPTION OF THE DRAWINGS

FIG. 1 is a front elevation view of a solution container with a closure comprised of an inner dropper cap and an overcap according to one example embodiment of the present invention, the container shown in a closed configuration.

FIG. 2 is a side elevation view of the solution container of FIG. 1.

FIG. 3 is a perspective view of an upper portion of the container of FIG. 1, showing features of the dropper and a part of the neck.

FIG. 4 is a side elevation view of the inner dropper cap shown in FIG. 1.

FIG. 5 is a cross section view of the inner dropper cap taken at line ‘A’-‘A’ of FIG. 4.

FIG. 6 is a schematic view of a portion of serration on the inner dropper cap shown in FIG. 4.

FIG. 7 is a top view of the overcap of the closure shown in FIG. 1.

FIG. 8 is a side elevation view of the overcap shown in FIG. 7.

FIG. 9 is a cross section view of the overcap taken at line ‘A’-‘A’ of FIG. 7.

FIG. 10 is a bottom view of the overcap shown in FIG. 7.

FIG. 11 is a schematic view of a portion of serration on the inner dropper cap shown in FIG. 10.

FIG. 12 is a front elevation view of a solution container with a closure comprised of an inner dropper cap and an overcap according to another example embodiment of the present invention, the container shown in a closed configuration.

FIG. 13 is a bottom view of the solution container of FIG. 12.

FIG. 14 is a front elevation view of a solution container with a closure comprised of an inner dropper cap and an overcap according to another example embodiment of the present invention, the container shown in a closed configuration.

FIG. 15 is a bottom view of the solution container of FIG. 14.

FIG. 16 is a perspective view of a solution container with a closure comprised of an inner dropper cap and an overcap according to another example embodiment of the present invention, the container shown in a closed configuration.

FIG. 17 is a front elevation view of a solution container with a closure comprised of an inner dropper cap and an overcap shown in FIG. 16, the container shown in a closed configuration.

FIG. 18 is a side elevation view of the container shown in FIG. 16.

FIG. 19 is a bottom view of the solution container of FIG. 16.

### DETAILED DESCRIPTION OF EXAMPLE EMBODIMENTS

The present invention may be understood more readily by reference to the following detailed description of the invention taken in connection with the accompanying drawing figures, which form a part of this disclosure. Unless defined otherwise, all technical and scientific terms used herein have the same meaning as commonly understood by one of ordinary skill in the art to which this invention belongs. Generally, the nomenclature used herein is well known and commonly employed in the art. Conventional methods are used for carrying out the disclosed procedures, such as those provided in the art and various general references. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, reference to singular forms such as “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The invention relates to a lens care product that can be used both to treat contact lenses in a lens case and to treat contact lenses while worn in the eye. This invention enables an user not only to clean, disinfect, and rinse contact lenses in a lens case in a conventional manner (e.g., rubbing and/or soaking for a predetermined period of time) but also to clean and lubricate lenses anytime anywhere while still wearing them.

In one aspect, the invention provides a lens care product comprising a solution container containing a lens-cleaning solution, wherein the lens-cleaning solution has a suitable viscosity for in-eye cleaning and lubrication of lenses and is capable of cleaning, disinfecting, and/or rinsing a contact lens in a lens case, wherein the solution container includes a chamber for the solution, an upper neck ending with a dropper having a dispensing opening through which the solution is to be controllably administered directly into an open eye of an user and to be controllably dispensed into a lens case, and a closure for closing the dropper to provide a substantially liquid-impermeable seal for the dispensing opening, wherein at least one portion of the walls of the chamber is resiliently deformable to enable it to be squeezed and thereby force the solution from the chamber into the open eye or the lens case.

In various embodiments, the lens cleaning solution is a thickened lens care solution having a suitable viscosity for in-eye cleaning and lubrication of lenses. Preferably, the lens care solution is a multiple-purpose solution free of hydrogen peroxide.

The thickened lens care solution should have a viscosity sufficient low to enable it to be controllably dispensed from the solution container when subjected to applied hand and/or finger pressure to the container by an user, yet has a viscosity sufficiently large to prolong its staying time in the eye long enough for in-eye cleaning and lubrication of lenses. The thickened lens care solution has a viscosity of preferably from about 5 centipoises to about 25 centipoises, more preferably from about 10 centipoises to about 20 centipoises.

“To be controllably dispensed from the solution container” is intended to describe that a solution can be dispensed from the container in drop form into an open eye and in drops or stream form into a lens case, by applying hand and/or finger pressure to the container.

In accordance with the invention, the solution container comprises a main body and a closure. The main body includes a chamber for a solution, an upper neck ending with a dropper having a dispensing opening through which the solution is to be controllably administered directly into an open eye of an user and to be controllably dispensed into a lens case. The closure (or cap) is adapted to be releasably affixed to said container at the dispensing opening so as to provide a substantially liquid-impermeable seal.

The chamber is typically formed by a peripheral side wall and a closed bottom wall, and a top wall enclosing the upper end of the chamber. The top wall includes an integral upstanding neck which ends with a dropper having a dispensing opening (or a nipper). The dropper and the integral upstanding neck forms a continuation of the opening. The walls and the neck of the container are integral with each other. At least one portion of the walls of the chamber is resiliently deformable to enable it to be squeezed and thereby force the solution from the chamber into the open eye or the lens case.

The dropper has a tip in which a dispensing opening is formed. Preferably, the dropper is permanently or semi-permanently secured (for example, by sonic welding or using adhesive or the like or by friction fits) to the neck.

The neck preferably has screw threads thereon for releasably affixing the closure.

Any known suitable closures, which can be releasably affixed to a container of the invention at the dispensing opening so as to provide a substantially liquid-impermeable seal, can be used in the invention. Exemplary closures (or caps) include without limitation interference fit (snap-fit) caps, pivoted snap-fit caps, and screw caps.

Preferably, the closure is an assembly of an inner dropper cap and an overcap, wherein the inner dropper cap preferably comprises friction-fitting features on its external surface and the over cap comprises friction-fitting features on its inner surface. The friction-fitting features on the external surface of the inner dropper cap mate with the friction-fitting features on the inner surface of the overcap to semi-permanently attach them together so that the inner dropper cap cannot be easily removed from the overcap once installed.

An assembly of an inner dropper cap and an overcap has the following advantages over a single-part closure. First, an assembly can be easily designed to be perfectly aligned with the shoulder(s) (e.g., the peripheral edge of the top wall) of a container main body. Second, the design and manufacture of inner dropper caps and overcaps can be carried out separately so that one can quickly adapt styles and designs of the overcaps to consumer preferences and trends without having to change the inner dropper caps. As such, one can save time and cost associated with development and product testing.

Preferably, a closure of the invention can self-align to the body of a container and form a continuation of the peripheral wall of the container to provide a unitary appearance (i.e., unified contour of the body and closure of a container) and to provide aesthetic appeal.

A container of the invention is sized so as to be held or gripped in one hand by an human adult and to contain from about 15 ml to about 500 ml of a lens care solution. The shape of a container of the invention must promote consumer convenience and aesthetic appeal. Consumer convenience is provided by hand-fit gripping, easily squeezing to apply a lens care solution directly into an eye and into a lens case, portability (i.e., easily storing and carrying in pockets, purse or backpacks), and ease of storage.

The container of the invention can have a cylinder or non-cylinder shape so long that is not too narrow or thin. Where a container is too narrow or thin, it does not have enough width to stand securely on bathroom shelf nor enough volume to squeeze to apply a lens care solution directly into an eye and a lens case. The top view and/or horizontal cross-sections (i.e., cross-sections parallel to the bottom of the container) of the container generally can have a perimeter (periphery) of any shape, such as, for example, polygon, circle, oval, or oval-like. Oval-like, as used herein, refers to ovals, egg shapes, and the like. The horizontal-cross-sectional shape defined by the periphery of the container of the invention is preferably a continuous curve which promotes the convenience, ergonomics and aesthetic appeal of the present invention.

In a preferred embodiment, the top-view and/or horizontal cross-sections of the container have oval-like shapes (i.e., ellipses or the likes), diamond shapes with rounded edges, or polygon shapes with rounded edge. Such shapes may efficiently make use of bathroom shelf space because of its narrow and rectangular-like shape.

In a preferred embodiment, the top-view and/or horizontal cross-sections of the container have oval-like shapes (i.e., ellipses or the likes), diamond shapes with rounded edges, or polygon shapes with rounded edge and at least one of the front and back sides of a container of the invention has a bottom-flattened egg contour. Such shape can lower the gravity center of the container and promote stability on bathroom shelf. The gravity center of the container is located preferably in its lower half part. The width of the container should be less than % of the height (or length) so the bottles don't turn, but the container is not so thin that it would fail/lose stability or shingle.

More preferably, there are two indentations positioned on opposite front and back sides of the container. The term “indentation”, as used herein, refers to notches, nicks, impressions, cut-outs, or other shapes which provide differentiation in the peripheral side wall sufficient to enable a user to easily grip the container. The two indentations can function as gripping areas for a user to easily grasp the container during handling of the lens care system. Preferably, the shapes of the two indentations approximately conform with overall shape of the container. Where at least one of the front and back sides of a container of the invention has a bottom-flattened egg contour, the two indentations preferably has an oval shape and vertically orientated. Verticality of the indentations provides easiness to grip and pour in eye and visual effects of their conformity with overall shape of the container. More preferably, the two indentations are positioned across the body and the closure of the container.

Preferably, the body of a container of the invention is made (e.g., molded) from a thermoplastic polymeric material, such as, for example, high density polyethylene, low density polyethylene, polypropylene, poly(ethylene terephthalate) and the like. It preferably has sufficient deformable resilience to enable it to be squeezed manually and thereby force the solution from the chamber into the open eye or the lens case, as desired.

The closure of a container of the invention is preferably constructed of a material which is sturdy plastic material. For example, polystyrene, high-density polyethylene, or polypropylene can be the construction material of choice, although others may be used.

In a preferred embodiment, the solution container is made from a translucent or clear material so as to provide interesting visual aesthetic appearance and a means for solution verification. More preferably, the container is colored and translucent or clear. Translucent or clear inner dropper caps and overcaps can provide a means for visual verification of sealing and leakage and piece of mind that an user can see the threads and feel assured that these products will not leak in purses or pockets or backpacks.

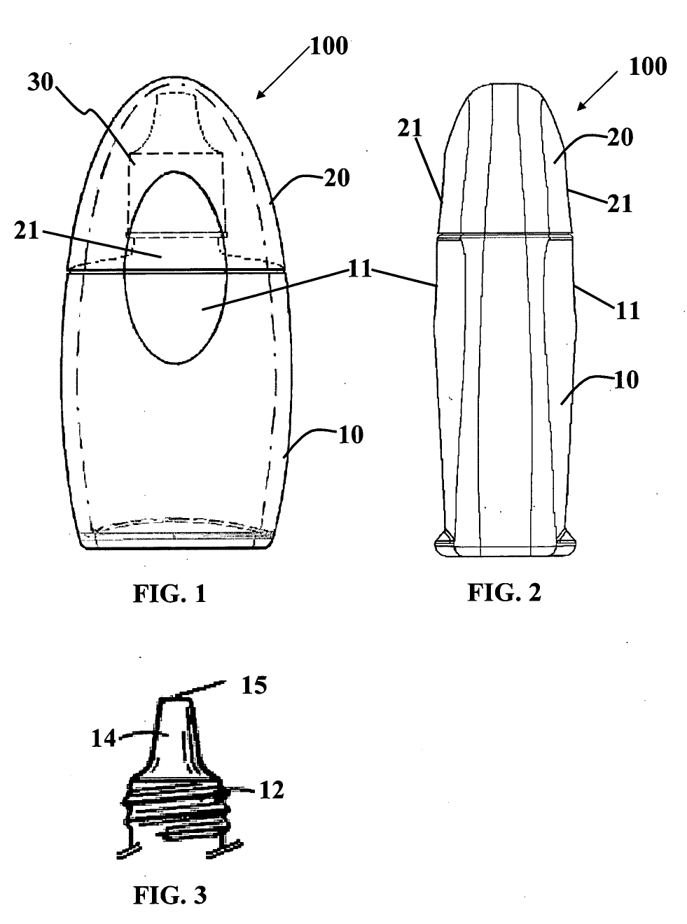

With reference now to the drawings, FIGS. 1-11 show a solution container 100 according to a first example embodiment of the present invention. The container includes a body 10 and a closure 20. The body 10 has a chamber for containing a lens care solution. The chamber is formed by a peripheral side wall, a closed bottom wall, and a top wall enclosing the upper end of the chamber. The top wall includes an integral, upstanding neck 12 which ends with a dropper tip 14 having a dispensing opening 15 (or a nipper) (see FIG. 3). The dropper tip and the integral upstanding neck forms a continuation of the opening. The walls and the neck of the container are integral with each other.

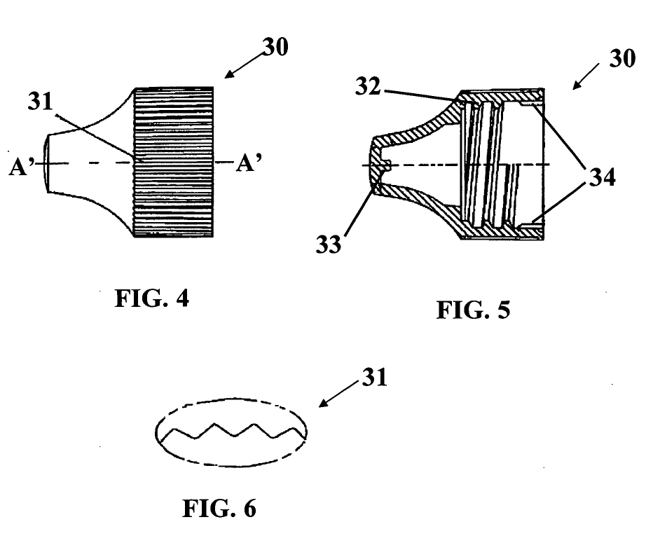

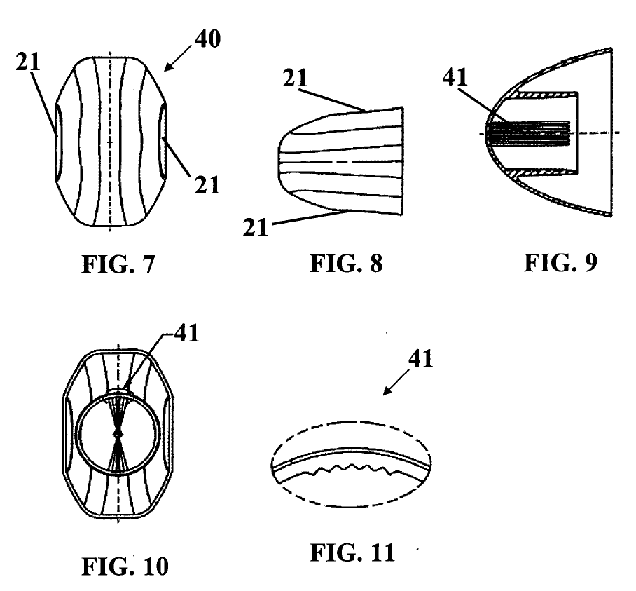

The closure 30 is releasably affixed to the neck 12 by using screw threads on the neck 12 and the closure 30, to provide a substantially liquid-impermeable seal for the dispensing opening 15. The closure 20 is an assembly of an inner dropper cap 30 (FIGS. 4-6) and an overcap 40 (FIGS. 7-11).

The inner dropper cap 30 preferably is a circular in a horizontal cross-sectional view. It comprises an inner surface, an outer surface, and a central stopper pin 33 is positioned on the top of the inner surface. Preferably, double lead threads 32 and about 12 unscrewing lug 34 are formed on the inner surface for releasably affixing the inner dropper cap 30 to the neck 12 of the container 100. The top inner surface of the inner dropper cap is designed to accommodate the external surface of the dropper 14. In the close position, the central stopper pin 33 engages the dispensing opening 15 while the top inner surface of the inner dropper cap 30 engages the external surface of the dropper 14 to provide a substantially liquid-impermeable seal to the container 100. The inner dropper cap 30 preferably comprises serrations as friction-fitting features, for example, about 60 serrations, equally spaced on its outer surface. It is understood that various numbers of serrations can be used in the invention.

The overcap 40 comprises an inner surface for engaging the inner dropper cap 30 to form the closure assembly 20. Serrations friction-fitting features, for example, about two pairs of about 6 serrations 41, are positioned oppositely on the inner surface of the overcap 40. The closure 20 is designed to be capable of self-aligning to the body of the container 100 in the close position. It is understood that odd or even numbers of serrations can be used in the invention.

The inner dropper cap 30 and the overcap 40 are assembled semi-permanently by friction fits between the serrations on the external surface of the inner dropper cap 30 and on the inner surface of the overcap.

The top wall of the container body 10 preferably has an upper continuous depression around its peripheral edge that positively engages an engagement surface formed by a bottom edge of the overcap 40 with snap in place, thereby forming a continuation of the peripheral wall of the body 10 of the container 100 to provide an unitary appearance (i.e., unified contour of the body and closure of a container).

As shown in FIGS. 1-2, the container 100 preferably has a smoothly-contoured outer surface with no sharp corners or edges. The front and/or back contour has a bottom flattened oval shape (FIG. 1). It is believed that such shape provides not only aesthetic appeal and but also functionalities such as standing stability on bathroom shelf (by lowering the gravity center), a good feel in the hand when holding up to eye and pouring into a lens case, and easiness to controllably dispense a lens care solution into an eye and a lens case. Preferably, the front and back bottom peripheral edges of the body 10 of the container 100 extends outwardly to increase the area of the bottom of the container 100 and thereby to enhance the standing stability on bathroom shelf (FIG. 2).

Preferably, one indentation (11 or 21) is formed on each of the front and back side of the body 10 and the closure 12. When the closure 12 is in close position, the indentations 11 and 12 together has an unitary appearance of an oval shape which is orientated vertically and visually conforms with the front and/or back contour of the container 100 (FIG. 1). The indentations 11 and 12 allow an user to easily squeeze the container to apply a lens care solution directly into an eye and a lens case.

In a typical commercial embodiment, the body 10, the overcap 40, the inner dropper cap 30, and the dropper 14 independently from each other are integrally formed as single pieces. These components of the container 14 are preferably made (e.g., molded) from a thermoplastic polymeric material, for example, high density polyethylene, low density polyethylene, polypropylene, poly(ethylene terephthalate) or the like. The material selected for the body 10 preferably has sufficient flexibility and resiliency to permit the user to squeeze opposed sides of the hollow body inwardly to controllably dispense lens care solution out of the container directly into an eye and a lens case. While the container 100 can be provided in various sizes, its dimensions are preferably selected to permit a juvenile or adult human user to readily grasp and squeeze the container with one hand to dispense lens care solution. In an example form, the container 100, which has a capacity of about 30 ml of a lens care solution has a height of about 9 cm (from the bottom wall to the top of the closure), a width of about 4 cm (from one side wall to the other side wall), and a depth of about 2.5 cm (from the front face to the back face). In another example, the container 100, which has a capacity of about 120 ml of a lens care solution has a height of about 13 cm, a width of about 6 cm, and a depth of about 4 cm.

Preferably, the body 10, the overcap 40, and the inner dropper cap 30 each are made from a translucent or clear material so as to provide interesting visual aesthetic appearance and a means for solution verification. More preferably, the body 10, the overcap 40, and the inner dropper cap 30 are both colored and translucent or clear. Translucent or clear inner dropper caps and overcaps can provide a means for visual verification of sealing and leakage and piece of mind that an user can see the threads and feel assured that these products will not leak in purses or pockets or backpacks. Any color can be used in the invention. The preferred color is blue or green or beige. The most preferred color is light blue.

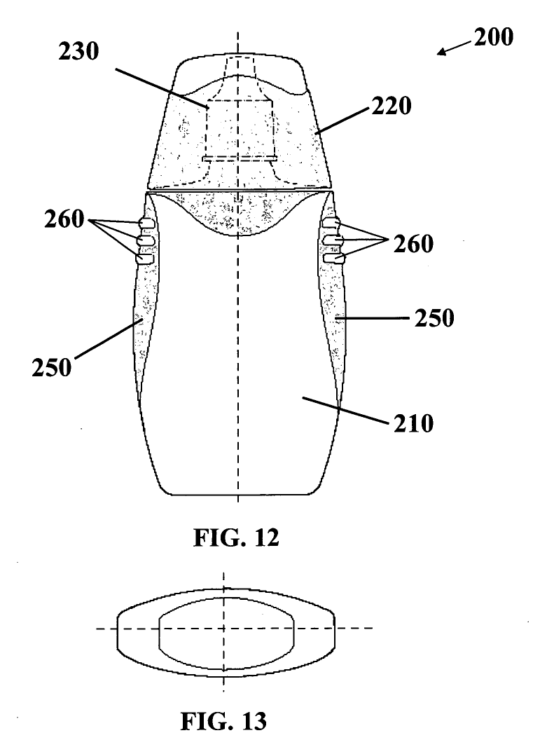

FIGS. 12-13 show a container 200 according to a second example embodiment. This container 200 includes a body 210 and a closure 220. The body 210 has a chamber for containing a lens care solution. The chamber is formed by a peripheral side wall, a closed bottom wall, and a top wall enclosing the upper end of the chamber. The top wall includes an integral, upstanding neck which ends with a dropper having a dispensing opening (or a nipper). The dropper and the integral upstanding neck forms a continuation of the opening. The peripheral wall is composed of a front wall, a back wall, and two opposing side walls. Each of the two opposite side walls has a gripping area 250 which preferably has a surface with increased gripping friction provided by surface irregularities, for example, ribs, ridges 260, raised dots, raised lines, indented grooves or dots, surface textures, or combinations thereof.

The closure 220, similar to the closure 20 of the first embodiment, is an assembly of an inner dropper cap 230 and an overcap. The closure 220 is releasably affixed to the neck by using screw threads on the neck and the closure 220, to provide a substantially liquid-impermeable seal for the dispensing opening. The closure 220 can self-align to the body 210 of the container 200 and forms a continuation of the peripheral wall of the container to provide a unitary appearance and aesthetic appeal.

The shade areas shown in FIG. 12 has a different color to provide a aesthetic appeal.

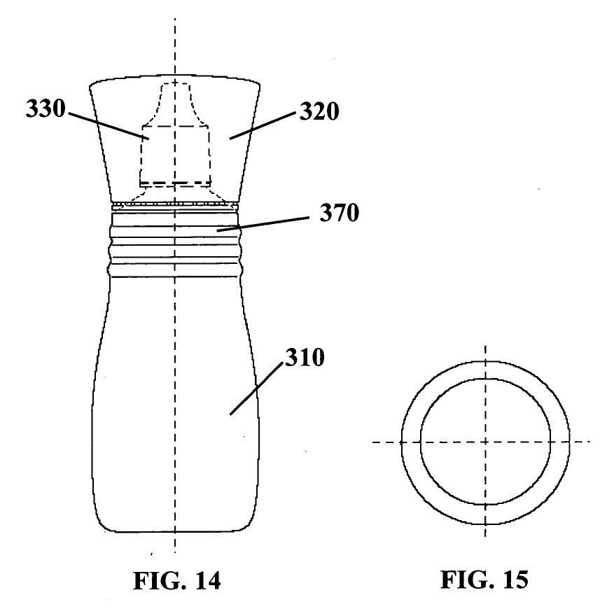

FIGS. 14-15 show a container 300 according to a third example embodiment. This container 300 includes a body 310 and a closure 320. The body 310 has a chamber for containing a lens care solution. The chamber is formed by a peripheral side wall, a closed bottom wall, and a top wall enclosing the upper end of the chamber. The top wall includes an integral, upstanding neck which ends with a dropper having a dispensing opening (or a nipper). The dropper and the integral upstanding neck forms a continuation of the opening. The peripheral wall of the body 310 has a gripping area 370 positioned near the top wall. The griping area has raised rings to increase gripping friction.

The closure 320, similar to the closure 20 of the first embodiment, is an assembly of an inner dropper cap 330 and an overcap. The closure 320 is releasably affixed to the neck by using screw threads on the neck and the closure 320, to provide a substantially liquid-impermeable seal for the dispensing opening. The closure 320 can self-align to the body 310 of the container 300 and forms a continuation of the peripheral wall of the container to provide a unitary appearance and aesthetic appeal.

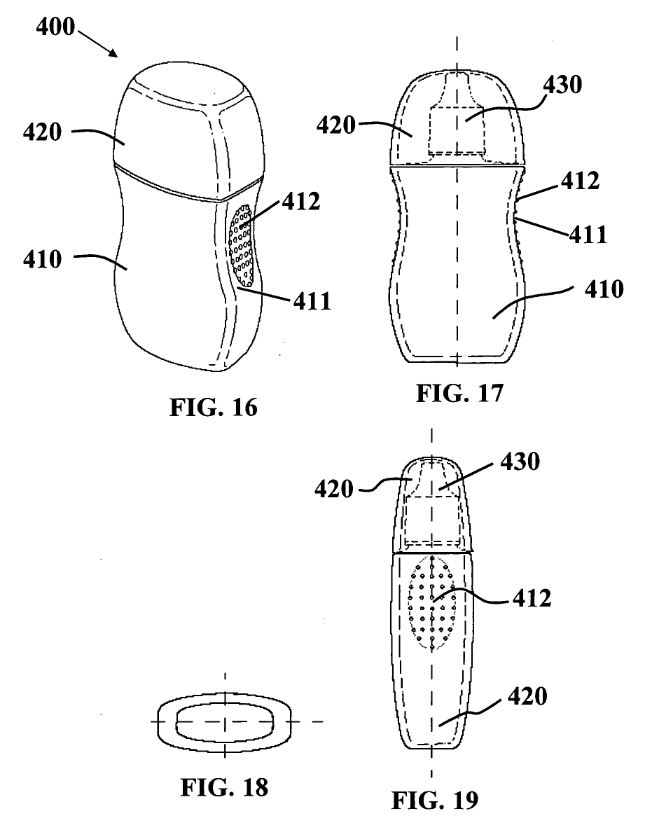

FIGS. 16-19 show a container 400 according to a fourth example embodiment. This container 400 includes a body 410 and a closure 420. The body 410 has a chamber for containing a lens care solution. The chamber is formed by a peripheral side wall, a closed bottom wall, and a top wall enclosing the upper end of the chamber. The top wall includes an integral, upstanding neck which ends with a dropper having a dispensing opening (or a nipper). The dropper and the integral upstanding neck forms a continuation of the opening. The peripheral wall is composed of a front wall, a back wall, and two opposing side walls. The two opposing side walls each have a recessed portion 411, with the opposing recessed portions cooperatively functioning as gripping areas for a user to easily grasp and handle the container.

The recessed gripping portions 411 may be inwardly curved surfaces, notches, or indentations that a narrower horizontal cross-section of the peripheral side wall sufficient to enable a user to easily grasp the container. The recessed gripping portions 411 preferably have surfaces 412 with increased gripping friction provided by surface irregularities, for example, ribs, ridges, raised dots, raised lines, indented grooves or dots, surface textures, or combinations thereof. The gripping surfaces 412 may be integrally formed with the container body 410 or applied separately as additional layers.

In the example embodiment shown, the recessed gripping surfaces 412 have surface irregularities in the form of a series of outwardly raised dots extending, which provide a more secure grip. The gripping surfaces 412 preferably have a generally constant radius of curvature, or a radius of curvature that progressively decreases toward the uppermost portions of the gripping surfaces, to provide the user with an outwardly and downwardly flared surface of contact, for enhanced stability and gripping contact when lifting the container and handling it to dispense lens care solution therefrom.

The closure 420, similar to the closure 20 of the first embodiment, is an assembly of an inner dropper cap 230 and an overcap. The closure 220 is releasably affixed to the neck by using screw threads on the neck and the closure 220, to provide a substantially liquid-impermeable seal for the dispensing opening. The closure 420 can self-align to the body 410 of the container 400 and forms a continuation of the peripheral wall of the container to provide a unitary appearance and aesthetic appeal.

Although various embodiments of the invention have been described using specific terms, devices, and methods, such description is for illustrative purposes only. The words used are words of description rather than of limitation. It is to be understood that changes and variations may be made by those skilled in the art without departing from the spirit or scope of the present invention, which is set forth in the following claims. In addition, it should be understood that aspects of the various embodiments may be interchanged either in whole or in part. Furthermore, titles, headings, or the like are provided to enhance the reader's comprehension of this document, and should not be read as limiting the scope of the present invention. Accordingly, the spirit and scope of the appended claims should not be limited to the description of the preferred versions contained therein.

What is claimed is:

1. A lens care product, comprising:
a solution container; and
a lens-cleaning solution contained in the solution container,
wherein the lens-cleaning solution is capable of cleaning, disinfecting, and/or rinsing a contact lens in a lens case and capable of cleaning and lubricating the contact lens directly in an eye,
wherein the lens-cleaning solution have a viscosity sufficient low to enable it to be controllably dispensed from the solution container when subjected to applied hand and/or finger pressure to the container by an user and sufficiently large to prolong its staying time in the eye long enough for in-eye cleaning and lubrication of the contact lens,
wherein the solution container includes a main body and a closure,
wherein the main body includes a solution-containing chamber formed by a peripheral side wall and a closed bottom wall, and a top wall enclosing the upper end of the chamber,
wherein the top wall includes an integral upstanding neck ending with a dropper having a tip in which a dispensing opening is formed,
wherein the dropper and the integral upstanding neck forms a continuation of the opening,
wherein the closure is adapted to be releasably affixed to said container at the dispensing opening so as to provide a substantially liquid-impermeable seal for the dispensing opening,
wherein at least one portion of the walls of the chamber is resiliently deformable to enable it to be squeezed and thereby force the solution from the chamber through the dispensing opening into the eye or the lens case.

2. The lens care product of claim 1, wherein the lens care solution has a viscosity of from about 8 centipoises to about 25 centipoises.

3. The lens care product of claim 2, wherein the closure is an assembly of an inner dropper cap and an overcap.

4. The lens care product of claim 3, wherein the inner dropper cap comprises friction-fitting features on its external surface and the overcap comprises friction-fitting features on its inner surface, wherein the friction-fitting features on the external surface of the inner dropper cap mate with the friction-fitting features on the inner surface of the overcap to semi-permanently attach them together.

5. The lens care product of claim 4, wherein the inner dropper cap is circular in a horizontal cross-sectional view and comprises an inner surface, an external surface, and a central stopper pin positioned on the top of the inner surface, wherein at least the top inner surface of the inner dropper cap is designed to accommodate the external surface of the dropper, wherein in close position of the closure the central stopper pin engages the dispensing opening while the top inner surface of the inner dropper cap engages the external surface of the dropper to provide the substantially liquid-impermeable seal for the dispensing opening.

6. The lens care product of claim 5, wherein the inner dropper cap comprises a first set of serrations equally spaced on its external surface while the overcap comprises a second set of serrations positioned on its inner surface, wherein the first and second sets of serrations engage with others to provide means for semi-permanently attaching the inner dropper cap and the overcap together.

7. The lens care product of claim 3, wherein the closure is capable of, in close position, self-aligning to the main body of the container and forming a continuation of the peripheral wall of the container to provide a unitary appearance and to provide aesthetic appeal.

8. The lens care product of claim 7, wherein top wall of the main body has an upper continuous depression around its peripheral edge that positively engages an engagement surface formed by a bottom edge of the overcap with snap in place, thereby forming a continuation of the peripheral wall of the body of the container to provide an unitary appearance.

9. The lens care product of claim 7, where the container is sized so as to be held or gripped in one hand by an human adult and to contain from about 15 ml to about 150 ml of a lens care solution.

10. The lens care product of claim 9, wherein the container has a cylinder or non-cylinder shape that has enough width to stand securely on a bathroom shelf and enough volume to be squeezed for applying the solution directly into the eye and the lens case.

11. The lens care product of claim 10, wherein the top-view and/or horizontal cross-sections of the container have oval-like shapes, diamond shapes with rounded edges, or polygon shapes with rounded edges.

12. The lens care product of claim 11, wherein the at least one of the front and back sides of the container has a bottom-flattened egg or oval contour.

13. The lens care product of claim 12, wherein the width of the container is less than 34 of the height.

14. The lens care product of claim 12, wherein the container includes two indentations each positioned on opposite front and back sides of the container for providing gripping areas for a user to easily grasp the container during handling of the lens care product.

15. The lens care product of claim 14, wherein the shapes of the two indentations approximately conform with overall shape of the container.

16. The lens care product of claim 14, wherein the two indentations each have an oval shape and are vertically orientated.

17. The lens care product of claim 14, wherein each of the two indentations is positioned across the main body and the closure.

18. The lens care product of claim 14, wherein the solution container is made from a translucent or clear material so as to provide interesting visual aesthetic appearance and a means for solution verification.

19. The lens care product of claim 14, wherein at least the main body and the overcap are colored.

20. The lens care product of claim 14, wherein the inner dropper cap and the overcap are clear or translucent to provide a means for visual verification of sealing and leakage.

21. A container for administering a lens care solution directly into an eye and for dispensing the lens care solution in a lens case, comprising:
a main body and a closure,
wherein the main body includes a solution-containing chamber formed by a peripheral side wall and a closed bottom wall, and a top wall enclosing the upper end of the chamber,
wherein the top wall includes an integral upstanding neck ending with a dropper having a tip in which a dispensing opening is formed,
wherein the dropper and the integral upstanding neck forms a continuation of the opening,
wherein the closure is an assembly of an inner dropper cap and an overcap and adapted to be releasably affixed to said container at the dispensing opening so as to provide a substantially liquid-impermeable seal for the dispensing opening,
wherein the closure is capable of, in close position, self-aligning to the main body of the container and forming a continuation of the peripheral wall of the container to provide a unitary appearance and to provide aesthetic appeal,
wherein at least one portion of the walls of the chamber is resiliently deformable to enable it to be squeezed and thereby force the solution from the chamber through the dispensing opening into the eye or the lens case.

22. The container of claim 21, wherein the solution container is made from a translucent or clear material so as to provide interesting visual aesthetic appearance and a means for solution verification.

23. The container of claim 22, wherein at least the main body and the overcap are colored.

24. The container of claim 22, wherein the inner dropper cap and the overcap are clear or translucent to provide a means for visual verification of sealing and leakage.

25. The container of claim 22, wherein the inner dropper cap comprises friction-fitting features on its external surface and the overcap comprises friction-fitting features on its inner surface, wherein the friction-fitting features on the external surface of the inner dropper cap mate with the friction-fitting features on the inner surface of the overcap to semi-permanently attach them together so that the inner dropper cap cannot be easily removed from the overcap once installed.

26. The container of claim 25, wherein the inner dropper cap is circular in a horizontal cross-sectional view and comprises an inner surface, an external surface, and a central stopper pin positioned on the top of the inner surface, wherein at least the top inner surface of the inner dropper cap is designed to accommodate the external surface of the dropper, wherein in close position of the closure the central stopper pin engages the dispensing opening while the top inner surface of the inner dropper cap engages the external surface of the dropper to provide the substantially liquid-impermeable seal for the dispensing opening.

27. The container of claim 26, wherein the inner dropper cap comprises a first set of serrations equally spaced on its external surface while the overcap comprises a second set of serrations positioned on its inner surface, wherein the first and second sets of serrations engage with others to provide means for semi-permanently attaching the inner dropper cap and the overcap together.

28. The container of claim 22, wherein top wall of the main body has an upper continuous depression around its peripheral edge that positively engages an engagement surface formed by a bottom edge of the overcap with snap in place, thereby forming a continuation of the peripheral wall of the body of the container to provide an unitary appearance.

29. The container of claim 22, wherein the container has a cylinder or non-cylinder shape that has a gravity center located in its lower half part, a width enough to stand securely on a bathroom shelf, and a volume adequate to be squeezed for applying the solution directly into the eye and the lens case.

30. The container of claim 29, wherein the top-view and/or horizontal cross-sections of the container have oval-like shapes, diamond shapes with rounded edges, or polygon shapes with rounded edges.

31. The container of claim 30, wherein the at least one of the front and back sides of the container has a bottom-flattened egg or oval contour.

32. The container of claim 31, wherein the container includes two indentations each positioned on opposite front and back sides of the container for providing gripping areas for a user to easily grasp the container during handling of the lens care product.

33. The container of claim 32, wherein the two indentations each have an oval shape and are vertically orientated.

34. The container of claim 33, wherein each of the two indentations is positioned across the main body and the closure.
